(19) United States
(12) Patent Application Publication
(10) Pub. No.: US 2020/0067374 A1
(43) Pub. Date: Feb. 27, 2020

(54) COOLING STRUCTURE FOR ROTARY ELECTRIC MACHINE

(71) Applicant: HIWIN MIKROSYSTEM CORP., Taichung City (TW)

(72) Inventors: Chen-An LI, Taichung City (TW); Ruei-Bin HSIAO, Taichung City (TW); Li-Wei CHENG, Taichung City (TW)

(21) Appl. No.: 16/106,467

(22) Filed: Aug. 21, 2018

(51) Int. Cl. H02K 5/20; H02K 9/19

(52) U.S. Cl. CPC H02K 5/20; B23Q 11/127; H02K 9/19

(57) ABSTRACT

A cooling structure for rotary electric machine is provided. The cooling structure for rotary electric machine comprises a sleeve and a plurality of dividers. The sleeve comprises an annular surface of a first half annular surface and a second half annular surface. The major dividers are configured on the annular surface of the sleeve in parallel to provide multiple major channels wherein each major divider comprises a major notch. The neighboring major dividers comprise two major notches configured on the first half annular surface and the second half annular surface respectively. Therefore, the major notches of the major dividers are arranged in a stagger configuration on the annular surface to form an interlaced path for the cooling liquid such that the cooling efficiency is enhanced

### BACKGROUND OF THE INVENTION

### Field of the Invention

The invention relates to a cooling structure, and more particularly to a cooling structure for the rotary electric machine.

### Description of the Related Art

As the development of the industrial automation, the rotary electric machine is widely applied to various machine tools for high speed rotation. With respect to the rotary electric machine, the iron loss of the stator and the copper loss of the coil result in the heat such that the deformation due to the heat would affect the accuracy of the machining during the operation of the rotary electric machine. Therefore, providing a jacket with a channel and injecting cooling liquid for heat exchange becomes the major means for heat dissipation of the rotary electric machine.

The conventional channel is designed as a non-cross and spiral channel wherein an inlet and an outlet are respectively configured at two ends of the channel such that the heat dissipation is achieved through the injection of the cooling liquid with the inlet and exhaust with the outlet. However, the continuous spiral channel has the cooling path with long distance, and the pressure drop occurs to result in that the fluid velocity of the cooling liquid is gradually decreased from the inlet to the outlet.

Consequently, mitigating the pressure drop within the channel to enhance the cooling efficiency through the modified channel structure becomes the challenge on heat dissipation of the rotary electric machine.

### SUMMARY OF THE INVENTION

In view of the disadvantages of prior art, the object of the present invention is to provide a cooling structure for rotary electric machine with the major notches of the major dividers in a stagger configuration on the annular surface to form an interlaced path for the cooling liquid such that the cooling efficiency is enhanced. Besides, the design of the descending channel number and channel width raises the fluid velocity of the cooling liquid and the thermal convection coefficient adjacent to the outlet to improve the heat exchange adjacent to the outlet such that the heat dissipation efficiency is enhanced. Furthermore, the dividers in the form of trapezoid configuration can increase the capacity of the channel such that the heat exchange is raised to enhance the heat dissipation efficiency.

To achieve the above object, the cooling structure for rotary electric machine comprises a sleeve and a plurality of dividers. The sleeve comprises an annular surface of a first half annular surface and a second half annular surface. The major dividers are configured on the annular surface of the sleeve in parallel to provide multiple major channels wherein each major divider comprises a major notch. The neighboring major dividers comprise two major notches configured on the first half annular surface and the second half annular surface respectively.

In one embodiment of the present invention, the cooling structure for rotary electric machine further comprises a jacket holding the sleeve and comprising an inlet and an outlet wherein the inlet and the outlet are configured on the opposite ends of the jacket and corresponding to the two major channels respectively.

In one embodiment of the present invention, the width of the major channel corresponding to the inlet is larger than the width of the major channel corresponding to the outlet.

In one embodiment of the present invention, the width of the major channel corresponding to the inlet is twice to three times as the width of the major channel corresponding to the outlet.

In one embodiment of the present invention, the cooling structure for rotary electric machine further comprises a plurality of minor dividers respectively configured within the major channels in parallel to provide multiple minor channels wherein each of the minor dividers comprises two minor notches configured on the first half annular surface and the second half annular surface respectively.

In one embodiment of the present invention, the number for the minor channels of the major channel corresponding to the inlet is larger than the number for the minor channels of the major channel corresponding to the outlet.

In one embodiment of the present invention, the number for the minor channels of the major channel corresponding to the inlet is twice to three times as the number for the minor channels of the major channel corresponding to the outlet.

In one embodiment of the present invention, the major dividers and the minor dividers are in the form of trapezoid configuration.

In one embodiment of the present invention, the major dividers and the minor dividers comprise a top portion and a bottom portion respectively wherein the top portion comprises a first length and the bottom portion comprises a second length. The first length is less than the second length.

In one embodiment of the present invention, the ratio of the first length and the second length is between 0.2-0.8.

Accordingly, the cooling structure for rotary electric machine with asymmetric first division regions and second division regions provides an interlaced path for the cooling liquid to enhance the cooling efficiency. Besides, the design of the descending channel number and channel width raises the fluid velocity of the cooling liquid and the thermal convection coefficient adjacent to the outlet to improve the heat exchange adjacent to the outlet such that the heat dissipation efficiency is enhanced. Furthermore, the dividers in the form of trapezoid configuration can increase the capacity of the channel such that the heat exchange is raised to enhance the heat dissipation efficiency.

### BRIEF DESCRIPTION OF THE DRAWINGS

FIG. 1 is an exploded view of the cooling structure for rotary electric machine of the first embodiment of the present invention;

FIG. 2 is a chart illustrating the variation of the pressure drop and the temperature depending on the first width and the second width;

FIG. 3 is a schematic view of the cooling structure for rotary electric machine of the second embodiment of the present invention;

FIG. 4 is a plan view of the cooling structure for rotary electric machine of the second embodiment of the present invention; and

FIG. 5 is a schematic view of the cooling structure for rotary electric machine of the third embodiment of the present invention.

### DETAILED DESCRIPTION OF THE PREFERRED EMBODIMENTS

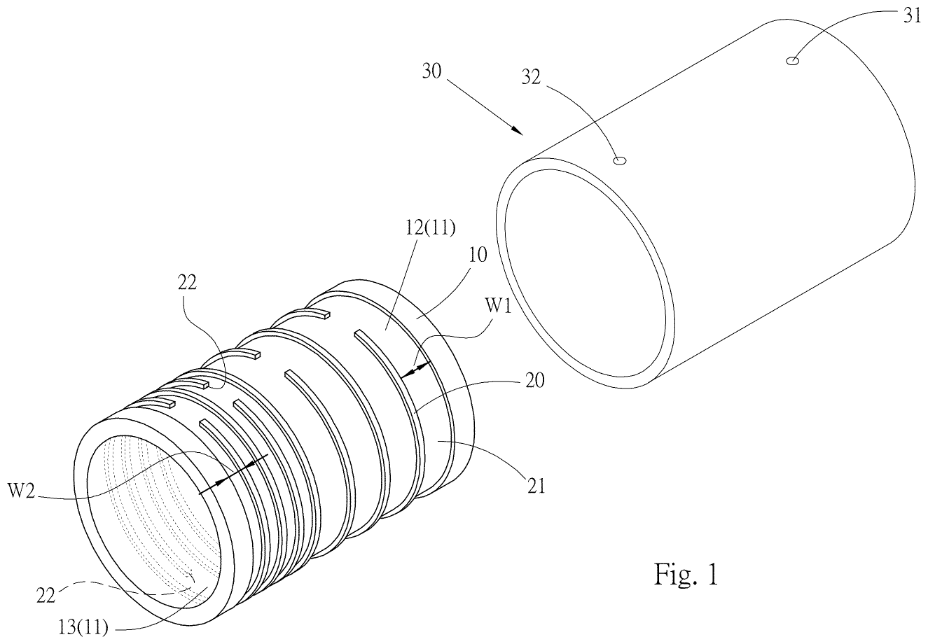

Refer to FIG. 1. The cooling structure for rotary electric machine comprises a sleeve 10 and a plurality of major dividers 20. The sleeve 10 comprises an annular surface 11 with a first half annular surface 12 and a second half annular surface 13 symmetric with each other. The major dividers 20 are configured on the annular surface 11 of the sleeve 10 to provide multiple major channels 21.

In this embodiment, the cooling structure for rotary electric machine further comprises a jacket 30 holding the sleeve 10 and comprising an inlet 31 and an outlet 32. The inlet 31 and the outlet 32 are configured on the opposite ends of the jacket 30 and corresponding to two major channels 21 respectively.

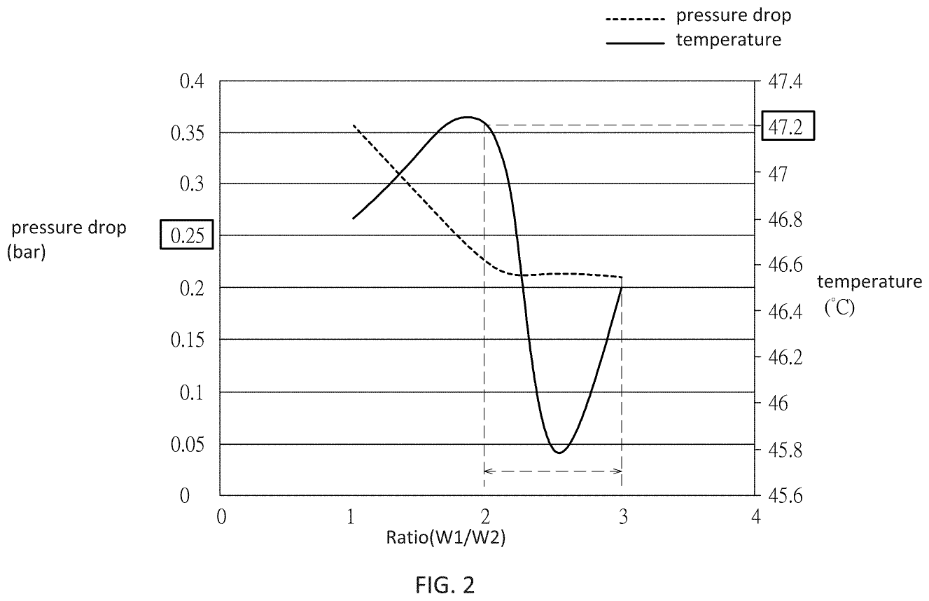

Each of the major dividers 20 comprises a major notch 22. The neighboring major dividers 20 comprise two major notches 22 configured on the first half annular surface 12 and the second half annular surface 13 respectively thereby arranging the major notches 22 in a stagger configuration on the annular surface 11. Moreover, the major channel 21 corresponding to the inlet 31 comprises a first width W1, and the major channel 21 corresponding to the outlet 32 comprises a second width W2 wherein the first width W1 is larger than the second width W2. Specifically, the major channel 21 next to the major channel 21 corresponding to the inlet 31 comprises a width less than the first width W1, and the major channel 21 next to the major channel 21 corresponding to the outlet 32 comprises a width larger than the second width W2 to provide the configuration of the descending channel width from the inlet 31 to the outlet 32. Refer to the chart in FIG. 2 illustrating the variation of the pressure drop and the temperature depending on the first width W1 and the second width W2, the temperature and the pressure drop are both decreased when the first width W1 is twice to three times as the second width W2.

As described above, the cooling structure for rotary electric machine of the first embodiment provides stagger major notches 22 on the annular surface 11 to form an interlaced path for the cooling liquid for higher heat dissipation efficiency than the prior continuous channel configuration. Moreover, the channel design with descending width raises the fluid velocity of the cooling liquid and the thermal convection coefficient adjacent to the outlet 32 to improve the heat exchange adjacent to the outlet 32 such that the heat dissipation efficiency is enhanced.

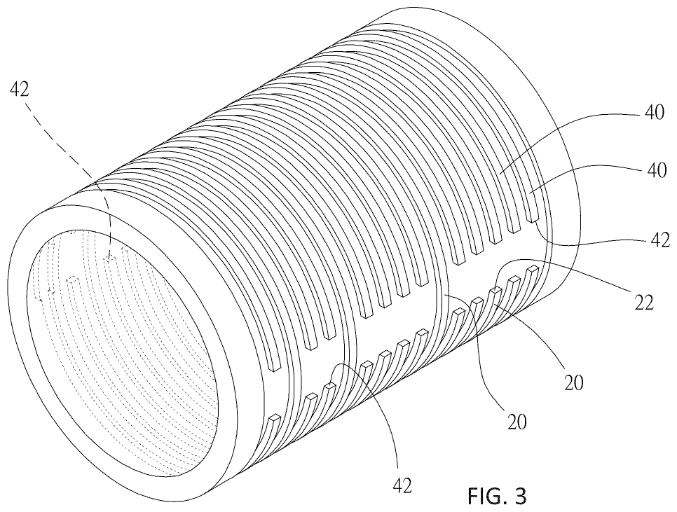

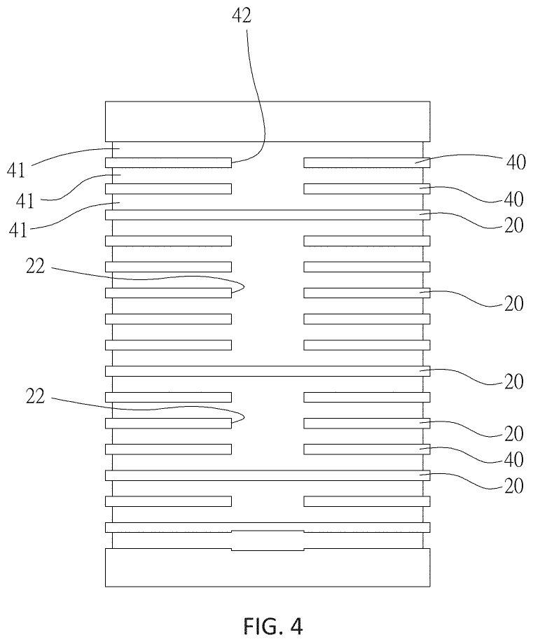

Refer to FIG. 3 and FIG. 4. Compared with the cooling structure for rotary electric machine of the first embodiment, the cooling structure for rotary electric machine of the second embodiment further comprises a plurality of minor dividers 40 respectively configured within the major channels 21 in parallel to provide multiple minor channels 41. Each minor divider 40 comprises two minor notches 42 configured on the first half annular surface 12 and the second half annular surface 13 respectively. In addition, a number for the minor channels 41 of the major channel 21 corresponding to the inlet 31 is larger than a number for the minor channels 41 of the major channel 21 corresponding to the outlet 32. In this embodiment, the number for the minor channels of the major channel corresponding to the inlet is twice to three times as the number for the minor channels of the major channel corresponding to the outlet.

Therefore, the cooling structure for rotary electric machine of the second embodiment provides parallel minor channels 41 with the descending channel number from the inlet 31 to the outlet 32 thereby reducing the fluid velocity of the cooling liquid and the thermal convection coefficient adjacent to the inlet 31, and raising the fluid velocity of the cooling liquid and the thermal convection coefficient adjacent to the outlet 32.

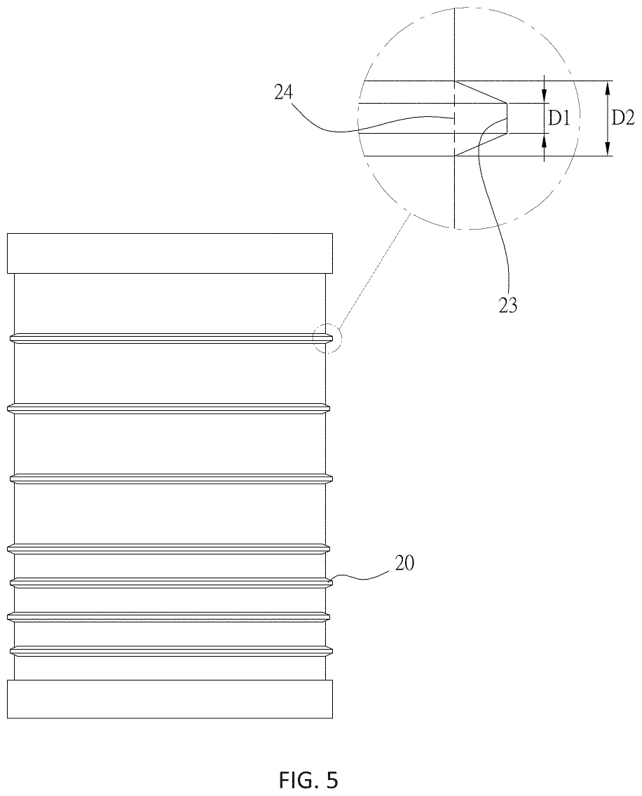

Refer to FIG. 5. Compared with the cooling structure for rotary electric machine of the first embodiment, the cooling structure for rotary electric machine of the third embodiment provides the major dividers 20 and the minor dividers 40 in the form of trapezoid configuration. Each major divider 20 comprises a top portion 23 with a first length D1 and a bottom 24 portion with a second length D2 wherein the first length D1 is less than the second length D2. Specifically, the ratio of the first length D1 and the second length D2 is between 0.2-0.8. Although the above description takes the major divider 20 for illustration, the same design rule can be also applied to the minor dividers 40 to provide the same trapezoid configuration.

The cooling structure for rotary electric machine of the third embodiment provides the dividers in the form of trapezoid configuration to increase the capacity of the channel such that the heat exchange is raised to enhance the heat dissipation efficiency.

Consequently, the cooling structure for rotary electric machine of the present invention includes the following advantages:

1. Compared with the prior continuous channel with the longer cooling path resulting in increasing pressure drop and decreasing the cooling efficiency, the cooling structure for rotary electric machine provides the major notches 22 of the major dividers 20 in a stagger configuration on the annular surface 11 to form an interlaced path for the cooling liquid such that the cooling efficiency is enhanced.
2. The design of the descending channel number and channel width raises the fluid velocity of the cooling liquid and the thermal convection coefficient adjacent to the outlet 32 to improve the heat exchange adjacent to the outlet 32 such that the heat dissipation efficiency is enhanced.
3. The dividers in the form of trapezoid configuration can increase the capacity of the channel such that the heat exchange is raised to enhance the heat dissipation efficiency.

It is to be understood that the above descriptions are merely the preferable embodiment of the present invention and are not intended to limit the scope of the present invention. Equivalent changes and modifications made in the spirit of the present invention are regarded as falling within the scope of the present invention.

1. A cooling structure for rotary electric machine, comprising:
a sleeve, comprising an annular surface of a first half annular surface and a second half annular surface; and
a plurality of major dividers, configured on the annular surface of the sleeve in parallel to provide multiple major channels wherein each of the major dividers comprises a major notch; the neighboring major dividers comprise two major notches configured on the first half annular surface and the second half annular surface respectively.

2. The cooling structure for rotary electric machine as claimed in claim 1, further comprising a jacket holding the sleeve and comprising an inlet and an outlet wherein the inlet and the outlet are configured on the opposite ends of the jacket and corresponding to the two major channels respectively.

3. The cooling structure for rotary electric machine as claimed in claim 2, wherein a width of the major channel corresponding to the inlet is larger than a width of the major channel corresponding to the outlet.

4. The cooling structure for rotary electric machine as claimed in claim 3, wherein the width of the major channel corresponding to the inlet is twice to three times as the width of the major channel corresponding to the outlet.

5. The cooling structure for rotary electric machine as claimed in claim 2, further comprising a plurality of minor dividers respectively configured within the major channels in parallel to provide multiple minor channels wherein each of the minor dividers comprises two minor notches configured on the first half annular surface and the second half annular surface respectively.

6. The cooling structure for rotary electric machine as claimed in claim 2, wherein a number for the minor channels of the major channel corresponding to the inlet is larger than a number for the minor channels of the major channel corresponding to the outlet.

7. The cooling structure for rotary electric machine as claimed in claim 6, wherein the number for the minor channels of the major channel corresponding to the inlet is twice to three times as the number for the minor channels of the major channel corresponding to the outlet.

8. The cooling structure for rotary electric machine as claimed in claim 1, wherein the major dividers and the minor dividers are in the form of trapezoid configuration.

9. The cooling structure for rotary electric machine as claimed in claim 8, wherein the major dividers and the minor dividers comprise a top portion and a bottom portion respectively; the top portion comprises a first length and the bottom portion comprises a second length wherein the first length is less than the second length.

10. The cooling structure for rotary electric machine as claimed in claim 9, wherein a ratio of the first length and the second length is between 0.2-0.8.
